(19) United States
(12) Patent Application Publication
(10) Pub. No.: US 2002/0159250 A1
(43) Pub. Date: Oct. 31, 2002

(54) Safety hat having alerting function

(76) Inventors: Yin Jyh Kuo, Taipei (TW); Hsin-Hao Yang, Taipei (TW)

Correspondence Address: KUO YIN JYH, P.O. BOX 27-757, TAIPEI, R.O.C., 106, TW

(21) Appl. No.: 09/845,076

(22) Filed: Apr. 25, 2001

(51) Int. Cl. F21V 21/084

(52) U.S. Cl. 362/106; 362/103; 362/473

(57) ABSTRACT

A safety hat having an alert function comprising a hat body, a battery, and a plurality of soft or hard light emitting strips, and a control switch. The hat body is like a shade. The soft light emitting strips are adhered on the surface and two lateral sides of the hat body. The battery is formed on the soft light emitting strips. One end of the control switch is connected to an electrode of the battery, and another end thereof is connected to the power supply end of the light emitting strip. By the action of the control switch, the soft light emitting strip lights up or extinguished. Thereby, a safety hat having an alert function is formed, which can be assembled by the user.

### FIELD OF THE INVENTION

The present invention relates to a safety hat having an alert function, which can be assembled by a user and has the function of emitting light for alerting.

### BACKGROUND OF THE INVENTION

In general, the safety hat having an alert function has a flash alerting circuit, light emitting elements or a rectangular array of LED display panel to be assembled to the hat body of a safety hat, such as Taiwan Patent Publication No. 212268, in which a groove is formed on the hat body for being installed with a flash alerting circuit, light emitting elements and a battery. Further, a cover having a reflecting casing and a focusing spacer is firmly secured thereon.

However, the flash alerting circuit must be specially designed to match the safety hat of the type for presenting an effect of alerting so that the cost is high and can no be assembly by user himself (or herself).

### SUMMARY OF THE INVENTION

Accordingly, the primary object of the present invention is to provide a safety hat having an alert function comprising a hat body, a battery, and a plurality of soft or hard light emitting strips, and a control switch. The hat body is like a shade. The soft light emitting strips are adhered on the surface and two lateral sides of the hat body. The battery is formed on the soft light emitting strips. One end of the control switch is connected to an electrode of the battery, and another end thereof is connected to the power supply end of the light emitting strip. By the action of the control switch, the soft light emitting strip lights up or extinguished. Thereby, a safety hat having an alert function is formed, which can be assembled by the user.

Another object of the present invention is to provide a safety hat having an alert function comprising a hat body, a battery, and a plurality of soft or hard light emitting strips, and a control switch. The hat body is like a shade and has a trench on the surface thereof. The soft light emitting strips are adhered on the trench and two lateral sides of the hat body. The battery is formed on the soft light emitting strips. One end of the control switch is connected to an electrode of the battery, and another end thereof is connected to the power supply end of the light emitting strip. By the action of the control switch, the soft light emitting strip lights up or extinguished. Thereby, a safety hat having an alert function is formed, which can be assembled by the user.

The various objects and advantages of the present invention will be more readily understood from the following detailed description when read in conjunction with the appended drawing.

### BRIEF DESCRIPTION OF THE DRAWINGS

FIG. 1 is a schematic view of the present invention.

FIG. 2 is an exploded view of the present invention.

FIG. 3 is a cross sectional view of the present invention.

FIG. 4 shows an embodiment of the present invention.

FIG. 5 is a cross sectional view of another embodiment in the present invention.

FIG. 6 is a perspective view showing an embodiment that the present invention is used to a safety hat of a bicycle.

### DETAILED DESCRIPTION OF THE PREFERRED EMBODIMENTS

To more understand the present invention by those skilled in the art, in the following, the details will be described with the appended drawings. However, all these descriptions are used to make one fully understand the present invention, while not to be used to confine the scope of the present invention defined in the appended claims.

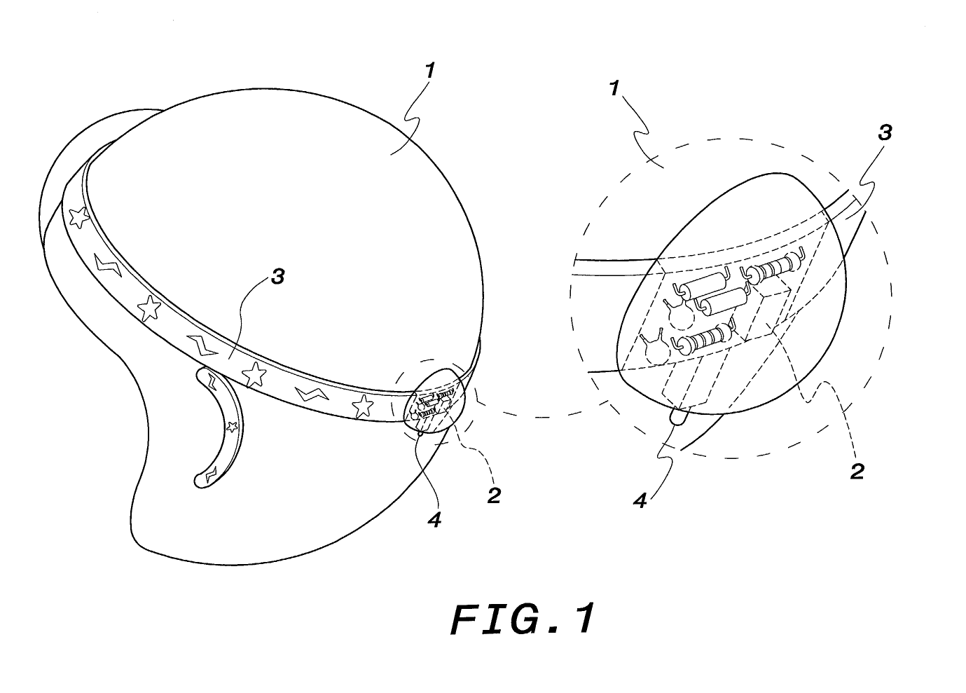

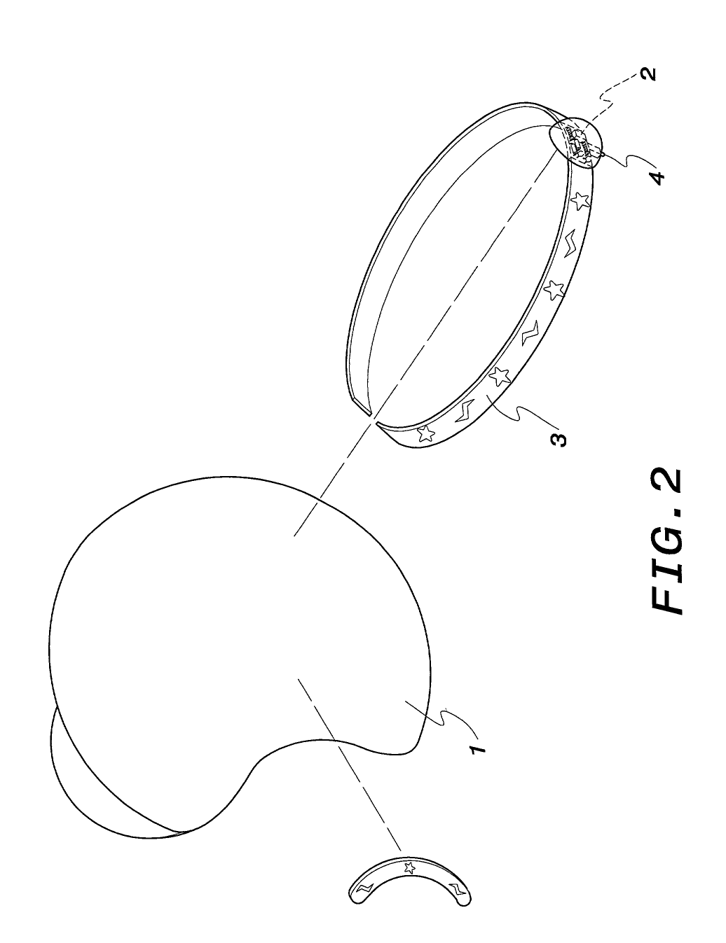

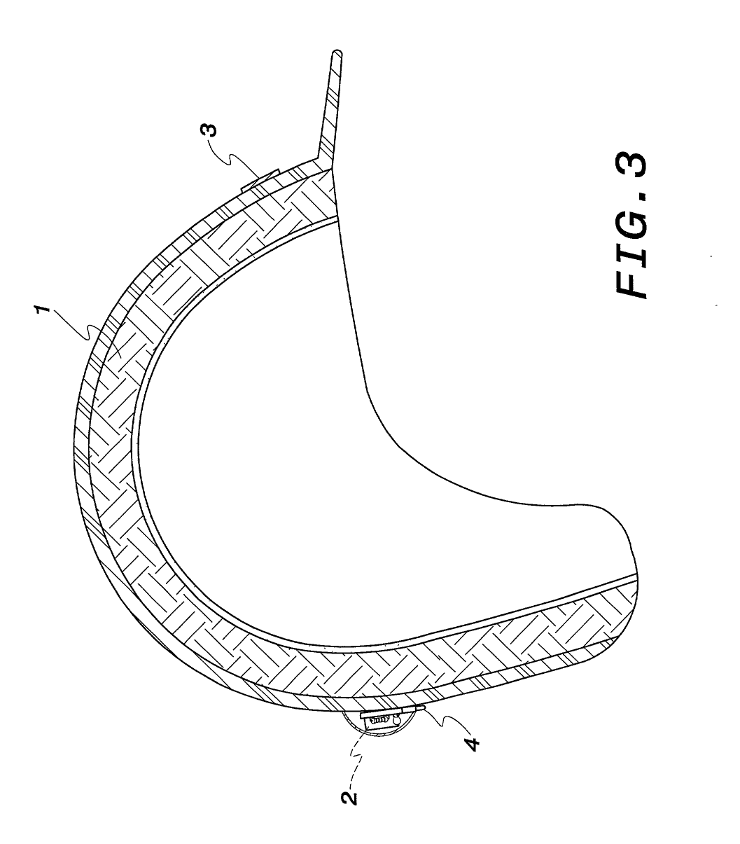

Referring to FIGS. 1 to 3, the safety hat having an alert function of the present invention is illustrated. The safety hat having an alert function according to the present invention includes a hat body 1, a battery 2, and a plurality of soft or hard light emitting strips 3, and a control switch 4.

The hat body 1 is like a shade.

The soft light emitting strips 3 are adhered on the surface and two lateral sides of the hat body 1.

The battery 2 is formed on the soft light emitting strips 3. The soft light emitting strip 3 emits light due to driving of the battery 2. If the battery 2 is insufficient in power or is ineffective, then the light emitting strips 3 will not emit light.

One end of the control switch 4 is connected to an electrode of the battery 2, and another end thereof is connected to the power supply end of the light emitting strip 3. By the action of the control switch 4, the soft light emitting strip 3 lights up or extinguished. Namely, as the control switch 4 is conductive, the battery 2 will supply power to the soft light emitting strips 3 so that the light emitting strips 3 will emit light. On the contrary, the light emitting strips 3 will extinguish.

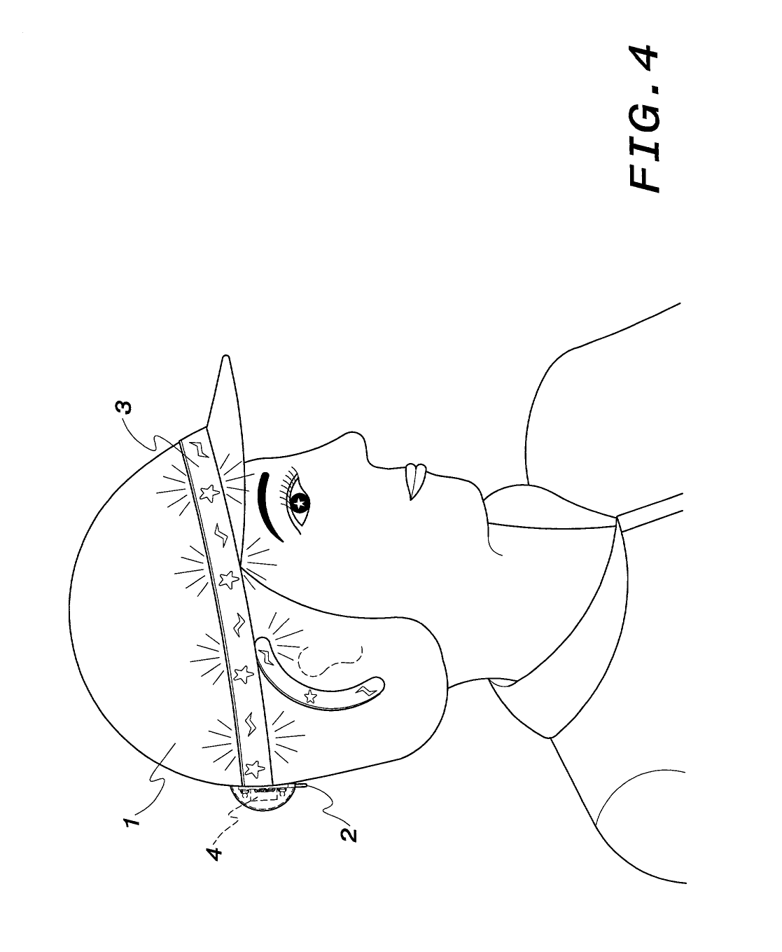

Thereby, as a use wears a safety hat, it is only necessary to press the control switch 4 to be conductive, then the soft light emitting strips 3 will emit light for alerting, as shown in the FIG. 4.

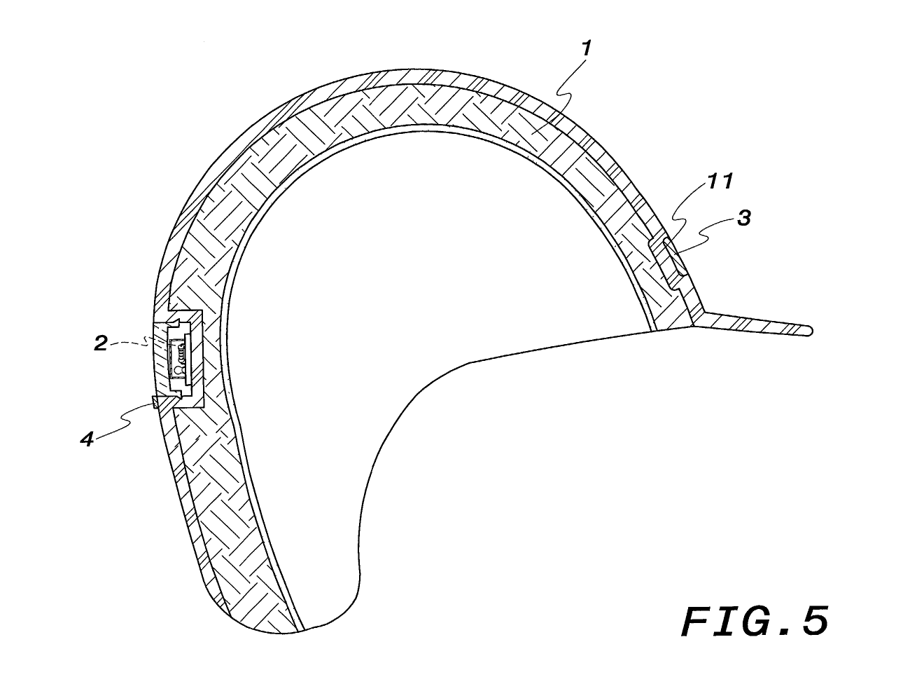

With reference to FIG. 5, a cross sectional view of another embodiment of the present invention is illustrated. A trench 11 is circularly installed on the surface of the hat body 1 for receiving a light emitting strip 3. The light emitting strip 3 is installed with a battery 2. An electrode of the battery 2 is connected to the power supply end of the soft light emitting strip 3 through the control switch 4. By the action of the control switch 4, the light emitting strip 3 can be tuned off or on so as to light up or extinguished.

Besides, in the present invention, a light sensitive resistor (not shown) is matched the control switch 4 (with a vibration sensor therein) so that as the light sensitive resistor is not radiated, the vibration sensor of the safety hat having an alert function will sense this non-radiating signal so as to automatically cause the light emitting strip 3 to light up. On the contrary, the light emitting strip 3 will not light up.

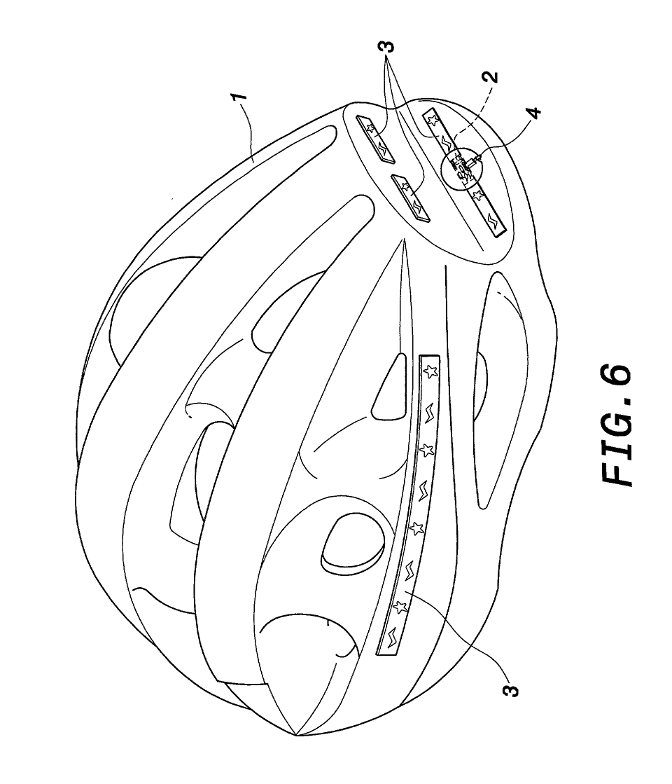

Furthermore, an application of the present invention is illustrated in FIG. 6, wherein the present invention is used to a safety hat of a bicycle, while the hats are adhered with protrusion strips on the outer surface. It is shown that the light emitting strips are adhered to the front and lateral sides of the hat.

Through the easy design of the present invention, the user may adhere the soft (or hard) light emitting strip and the battery directly or indirectly to the hat body so that the safety hat has a function of alerting.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A safety hat having an alert function comprising:
a hat body being formed as a shade;
a light emitting strip (soft or hard) being adhered to a surface of the hat;
a battery being installed on the light emitting strips; and
a control switch having one end connected to one electrode of the battery, and another end being connected to a power supply end of the light emitting strip for turning on or off the light emitting strip so as to light up or extinguish.

2. The safety hat having an alert function as claimed in claim 1, wherein the two sides of the safety hat are adhered with light emitting strips.

3. A safety hat having an alert function comprising:
a hat body being formed as a shade and having a trenching being formed on a surface thereof;
a light emitting strip (soft or hard) being adhered to the trench of the hat;
a battery being installed on the light emitting strip; and
a control switch having one end connected to one electrode of the battery, and another end being connected to a power supply end of the light emitting strip for turning on or off the light emitting strip so as to light up or extinguish.

4. The safety hat having an alert function as claimed in claim 3, wherein the two sides of the safety hat are adhered with light emitting strips.
